(19) United States
(12) Patent Application Publication
(10) Pub. No.: US 2004/0256190 A1
(43) Pub. Date: Dec. 23, 2004

(54) Clutch body for a gear-shifting and synchronizing device

(75) Inventor: Josef Schwuger, Hochstadt (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: INA-Schaeffler KG, Herzogenaurach (DE)

(21) Appl. No.: 10/872,691

(22) Filed: Jun. 21, 2004

Related U.S. Application Data
(63) Continuation of application No. PCT/EP02/13114, filed on Nov. 22, 2002.

(30) Foreign Application Priority Data
Dec. 21, 2001 (DE) 101 63 413.7

(51) Int. Cl. F16D 23/02

(52) U.S. Cl. 192/53.34; 192/107 R

(57) ABSTRACT

A clutch body (6) for a gear-shifting and synchronizing device is provided, in particular for motor-vehicle transmissions. The clutch body has a clutch disk (1) and a conical ring (5), wherein the clutch disk (1) is rotationally fixed to a gear wheel and has on its outer circumference a toothed section (7), which can be coupled to a counter-section of a sliding sleeve rotationally fixed to a transmission shaft, wherein the clutch disk (1) is produced from several parts (2, 2a, 3, 3a, or 4) and the parts (2, 2a, 3, 3a, or 4) are connected to each other.

### CROSS-REFERENCE TO RELATED APPLICATIONS

This application is a continuation of PCT/EP02/13114, filed Nov. 22, 2002, which claims the benefit of German application 101 63 413.7, filed Dec. 21, 2001.

### BACKGROUND

The invention relates to a clutch body for a gear-shifting and synchronizing device, in particular for motor-vehicle transmissions. The clutch body has a clutch disk and a conical ring. The clutch disk is at least rotationally fixed to a gear wheel and its external circumference is provided with a toothed section, which can be coupled to a counter-section of a sliding sleeve that is rotationally fixed to a transmission shaft.

It is known, EP 0 508 976 A1, for a gear-shifting and synchronizing device to provide a clutch disk, which is in active, rotationally fixed connection, on one hand, with the gear wheel, and, on the other, with a conical ring. More detailed information on the clutch disk is not found in this European Patent Application, because the application itself concentrates on the conical ring and its friction surface. However, from this document, it can be assumed that the clutch disk is a solid, one-piece component and that it is produced from solid material. Therefore, the clutch disk is expensive in production and exhibits a high weight.

### SUMMARY

Therefore, the object of the invention is to make available a clutch disk, which has an optimum shape, which can be produced by means of economical production technology, and which satisfies all necessary functions.

The solution to this objective of the invention is provided in that the clutch disk is produced in several parts and the parts are connected to each other. Through this configuration of the invention, it is possible to reduce the energy and material consumption during production to a minimum and also to improve the shaping of the surfaces and radii. It is definitely also conceivable to produce the clutch disk as a single part by means of forming technology. However, here very high forming forces could be necessary depending on the material and size of the clutch disk and the radii might not be able to be produced small enough.

These conceivable disadvantages are also overcome by a clutch disk, which is produced in several parts and which can also be produced in an advantageous way without machining by means of forming or pressing technology.

In the further configuration of the invention, the parts are connected to each other by clinching connections. In this way, the parts have fitting projections and recesses, which are back cut, so that after hooking the parts on one another, a total fastening in the plane of the clutch disk is given.

However, after their production, the parts can also have end surfaces, preferably flat end surfaces, at which the parts are welded to each other after mutual fixing.

According to the invention, the clutch disk or the parts can have openings, in which projections of the conical ring can engage. Therefore, the conical ring can be fixed to the clutch disk, so that this is held rotationally fixed and centered by the clutch disk.

Furthermore, the conical ring and the clutch disk can be connected, preferably by welding, to each other in a non-detachable way. In one case, this is possible in that the parts are welded into a clutch disk and then welded to each other in the region of the openings and the projections. However, it is also possible that the conical ring and the clutch disk are welded to each other continuously after fixing the parts. If the continuous welding is selected, then it is not necessary that the parts of the clutch disk are connected rigidly to each other, e.g., by welding. Then it is sufficient, namely that the parts are also fixed relative to each other and to the conical ring initially, e.g., by means of the clinching connections, because through the continuous welding, the parts and the conical ring are finally connected rigidly to each other.

### BRIEF DESCRIPTION OF THE DRAWINGS

For the further explanation of the invention, reference is made to the drawings, in which embodiments of the invention are shown. In the drawings:

FIG. 1 is a side view of a clutch disk, which is assembled from three parts,

FIG. 2 is a side view of parts, which are assembled form a clutch disk according to FIG. 1,

FIG. 3 is a side view of a modified clutch disk,

FIG. 4 is a clutch body in cross section, which has a clutch disk and a conical ring, and

FIG. 5 is a clutch body according to FIG. 4 in perspective representation.

### DETAILED DESCRIPTION OF THE PREFERRED EMBODIMENT

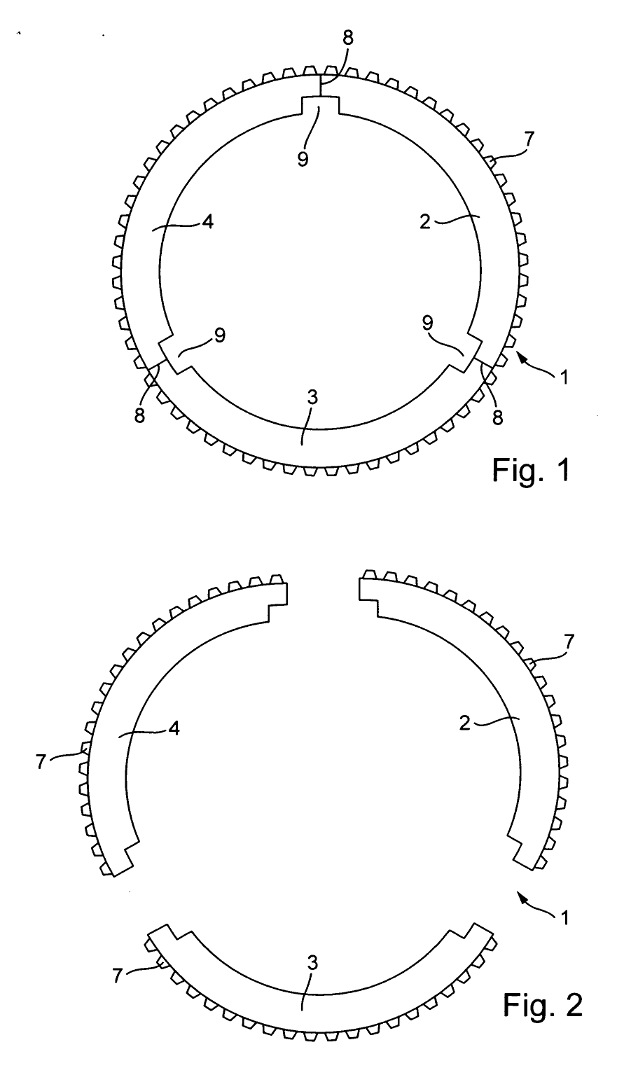

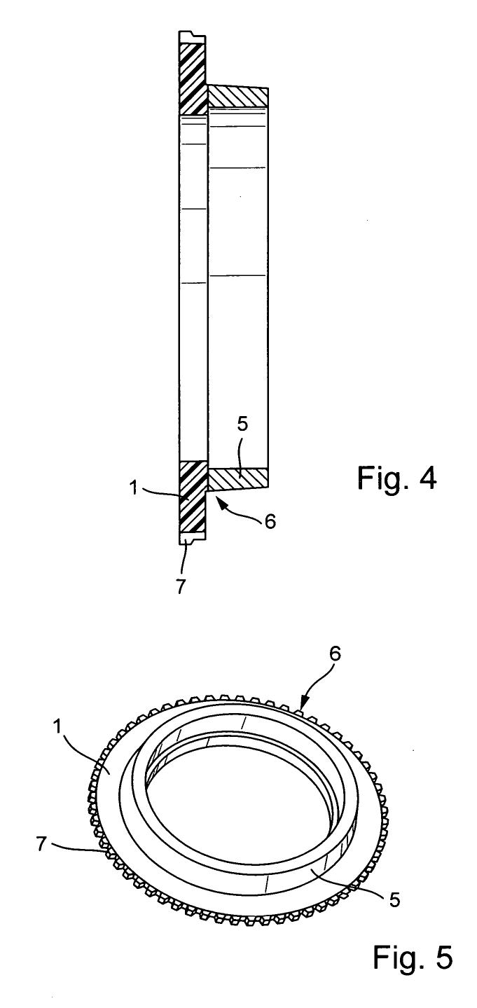

In FIGS. 1-5, as far as what is shown in detail, a clutch disk 1 is provided, which, according to the configuration, is built from two parts, 2a and 3a, or three parts, 2, 3, and 4. The clutch disk 1 is connected, in particular, welded, to a conical ring 5, as shown in FIGS. 4 and 5, so that the clutch disk 1 and the conical ring 5 together form the clutch body 6. The conical ring 5 is formed with a conical shape on its outer circumference, so that it becomes narrower outwards from the clutch disk and so that it can enter into active connection with an inner cone (not shown) of a synchronizer ring, which matches the cone of the conical ring 5.

The clutch disk 1 has on its outer circumference a toothed section 7, which matches a complementary shaped profile of a sliding sleeve (not shown), so that a rigid rotational connection between the clutch disk and the sliding sleeve can be produced after synchronization by means of the cones of the synchronizer ring and the conical ring 5.

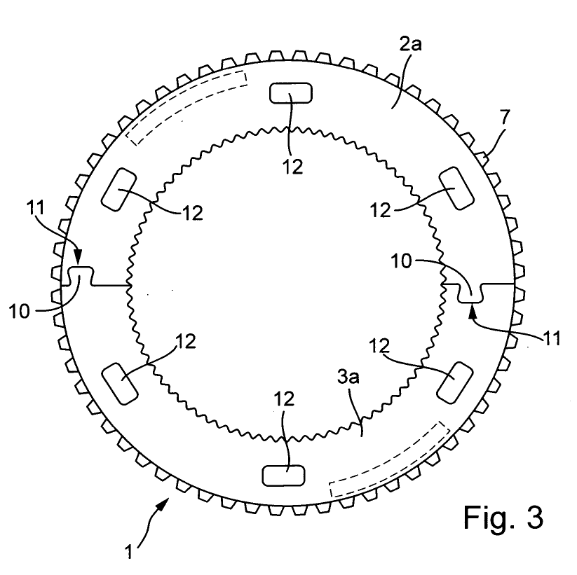

As shown in FIG. 1 and 2, the parts 2, 3, and 4 have end surfaces, with which the parts are welded together in a fitting way (FIG. 1) or which can be welded, because this is not yet performed in FIG. 2. The welding seams are designated in FIG. 1 with 8. The clutch disk according to FIG. 1 is connected, not shown, to a likewise not-shown gear wheel. Recesses 9 are provided, in which projections on the conical ring can engage. The clutch disk according to FIG. 3 is formed of two parts 2a and 3a, which can be locked relative to each other by means of clinching connections. For locking the parts by means of the clinching connections, each part has a projection designated with 10, which has an enlarged head. On the opposite side, a corresponding recess 11 is provided in each of the parts, which has an extension, into which the head of the opposite part projects. The symbol 12 designates additional openings, in which tabs (not shown) on the conical ring can engage.

As shown in FIG. 4, the clutch body designated with 6 is formed of two separate parts, namely the clutch disk 1 and the conical ring 5, which can be welded to each other also on their contact surface.

### LIST OF REFERENCE SYMBOLS

1 Clutch disk

2 Part

2a Part

3 Part

3a Part

4 Part

5 Conical ring

6 Clutch body

7 Toothed section

8 Welding seam

9 Recess

10 Projection

11 Recess

12 Opening

1. Clutch body (6) for a gear-shifting and synchronizing device for motor-vehicle transmissions, the clutch body comprising a clutch disk (1) and a conical ring (5), the clutch disk (1) is adapted to be at least rotationally fixed to a gear wheel and has on its outer circumference a toothed section (7), which is adapted to be coupled to a complementary shaped profile of a sliding sleeve rotationally fixed to a transmission shaft, the clutch disk (1) is produced in several parts (2, 2a, 3, 3a, or 4) and the parts (2, 2a, 3, 3a, or 4) are connected to each other.

2. Clutch body for a gear-shifting and synchronizing device according to claim 1, wherein the parts (2, 2a, 3, 3a, or 4) are produced without machining by a forming or pressing process.

3. Clutch body for a gear-shifting and synchronizing device according to claim 1, wherein the parts (2, 2a, 3, 3a, or 4) are fixed relative to each other by clinching connections (10 and 11).

4. Clutch body for a gear-shifting and synchronizing device according to claim 1, wherein the parts (2, 2a, 3, 3a, and 4) are welded to each other along welding seams (8).

5. Clutch body for a gear-shifting and synchronizing device according to claim 1, wherein the clutch disk (1) has openings (12), in which projections of the conical ring (5) engage.

6. Clutch body for a gear-shifting and synchronizing device according to claim 1, wherein the conical ring (5) and the clutch disk (1) are non-detachably connected to each other and form the clutch body (6).

7. Clutch body for a gear-shifting and synchronizing device according to claim 6, wherein the conical ring (5) and the clutch disk (1) are non-detachably connected to each other by welding.
